(19) United States
(12) Patent Application Publication
(10) Pub. No.: US 2010/0120346 A1
(43) Pub. Date: May 13, 2010

(54) VENTILATION FLAP ARRANGEMENT

(76) Inventor: Helge JANSEN, Ursenollen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/615,640

(22) Filed: Nov. 10, 2009

(30) Foreign Application Priority Data
Nov. 11, 2008 (DE) 10 2008 056 756.6

(51) Int. Cl. B60H 1/34; B23P 11/00

(52) U.S. Cl. 454/152; 29/428

(57) ABSTRACT

A ventilation flap arrangement, in particular for venting a motor vehicle interior, as well as a method for producing a ventilation flap arrangement of this type, which has the method steps of providing one or more flexible cover flaps, providing a frame for holding the cover flaps, wherein the frame for a cover flap has a receiving groove formed by two side cheeks, inserting the cover flap between the two side cheeks of the receiving groove of the frame and non-detachable connection of the cover flap to the receiving groove by embossing.

### FIELD OF THE INVENTION

The invention relates to a ventilation flap arrangement, in particular for venting a motor vehicle interior, with cover flaps and a frame for holding the cover flaps. Furthermore, the invention relates to a method for producing a ventilation flap arrangement of this type.

### BACKGROUND OF THE INVENTION

A ventilation flap arrangement with an inner frame, an outer housing and cover flaps is known from DE 40 02 052 A1, the cover flaps consisting of very soft, flexible material being clamped between the inner frame and the outer housing. A ventilation flap arrangement of this type is produced in a complex assembly process with many individual components.

It is furthermore known from DE 195 48 551 A1 that cover flaps are produced in one piece with a frame by means of conventional two-component injection moulding methods. These production methods require expensive tools and optionally injection moulding machines adapted thereto. The production of a ventilation flap arrangement by the multi-component injection moulding method is expensive.

It is also known from DE 195 48 551 A1 and from EP 0 645 268 A1 to fix the cover flaps by a clamping strip moulded onto the frame or by lugs attached thereon. Cover flaps fixed in this manner may be problematical with regard to a sealing abutment on the frame of a ventilation flap arrangement.

### SUMMARY OF THE INVENTION

The invention is based on the object of providing a ventilation flap arrangement and a method for producing a ventilation flap arrangement of this type with regard to an economical fastening of cover flaps to a frame in such a way that the number of components is reduced, assembly is simplified and the tightness of a ventilation flap arrangement is ensured.

This object is achieved from a product point of view by a ventilation flap arrangement according to the invention comprising a flexible cover flap being non-detachably connected to a receiving groove of a frame formed by two side cheeks by embossing. A venting flap arrangement of this type is easy to assemble and has a reduced number of components; in particular a separate clamping frame is no longer provided. As a result, tool investment costs and machine occupation times are reduced. At least one side cheek projects with an embossed projection into at least one opening configured close to the edge on the cover flap, so the non-detachable connection of the cover flap to the receiving groove can be implemented by a positive fit in a few small island-shaped joint regions. The cover flaps are produced from soft elastic material in order to guarantee a sealing abutment of the cover flaps on the frame. The cover flaps may have at least one notch to receive a reinforcement rib of a receiving groove corresponding with the notch. The frame has support ribs, on which the side cheeks of the receiving grooves are attached. The support ribs are also used for the sealing abutment of a cover flap attached on an adjacent support rib. The receiving grooves may be configured in such a way that they taper toward a groove base, so the insertion of the cover flaps into the receiving grooves is facilitated. An assembly shoulder on the frame of the ventilation flap arrangement allows a defined attachment of the ventilation flap arrangement in a venting channel.

A method for producing a ventilation flap arrangement comprises, apart from providing one or more flexible cover flaps and a frame with a receiving groove formed by two side cheeks, the insertion of the cover flap between the two side cheeks into the sealing groove as well as the non-detachable connection of the cover flap to the receiving groove by embossing. A method of this type has few manufacturing steps. The forming of the at least one side cheek with an embossing die so an embossed projection of the at least one side cheek projects into at least one opening configured close to the edge on the cover flap or at least holds the cover flap in a clamping manner, can be carried out in an automated and economical manner. By producing the embossed projections of the side cheeks by a embossing die pair acting thereon on both sides, the maximum forming of the side cheeks is reduced. Acting on the region to be embossed of the side cheek with temperatures in the range between a dimensional stability temperature and a melting temperature of a material to be embossed and/or ultrasound increases the formability of the material, from which the side cheeks are produced.

Further advantageous configurations of the invention, features and details of same are described in more detail in the following description with the aid of the drawings.

### BRIEF DESCRIPTION OF THE DRAWINGS

FIGS. 1 and 2 show cross-sections of a ventilation flap arrangement in different embodiments,

FIGS. 3 and 4 show plan views of cover flaps without and with notches,

FIGS. 5 and 6 show enlarged detail cross-sections of cover flaps during their attachment to a frame in a first intermediate production step,

FIGS. 7 and 8 show cross-sections analogous to FIGS. 5 and 6 in a subsequent intermediate production step with a one-sided embossing process in various embossing directions,

FIG. 9 shows a cross-section analogous to FIG. 8 with a one-sided embossing process with a formed side cheek of a receiving groove,

FIG. 10 to 12 show cross-sections that are increased again of one-sided embossing processes with formed side cheeks and

FIG. 13 shows a cross-section analogous to FIGS. 7 and 8 with a two-sided embossing process.

### DESCRIPTION OF THE PREFERRED EMBODIMENT

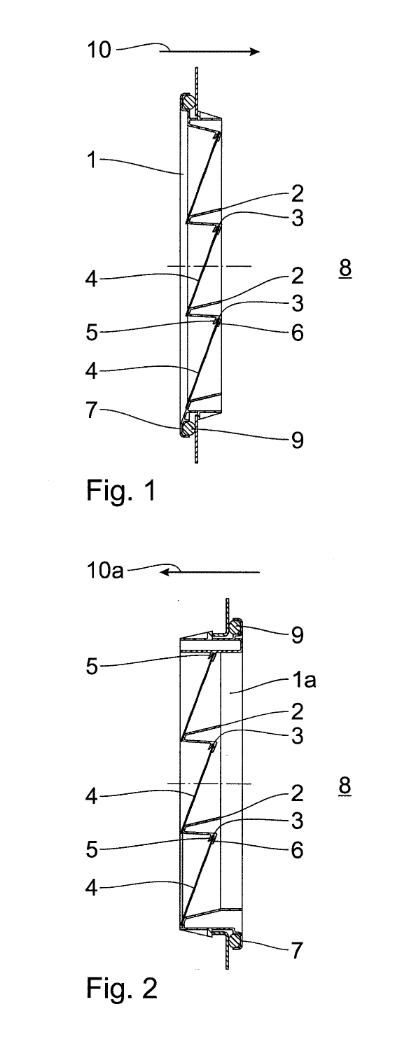

The ventilation flap arrangements shown in FIGS. 1 and 2 have a frame 1, 1a with a plurality of support ribs 2 and a plurality of receiving grooves 3 to hold cover flaps 4, each receiving groove 3 being formed by two side cheeks 5, which are moulded in one piece on the frame 1, 1a. For easier introduction of the cover flap 4 into the receiving groove 3, the side cheeks 5 may in each case have an insertion bevel oriented toward the receiving groove 3. The receiving groove 3 may comprise a plurality of reinforcement ribs 15 (cf. FIG. 6), which are moulded in one piece on the support rib 2 between the two side cheeks 5 in a groove base 6. The reinforcement ribs 15 are used to stabilise the receiving groove 3 formed by the side cheeks 5, so a possible distortion of the side cheeks 5 and therefore a shape deviation of the receiving groove 3 as a result of a previous production method, in particular an injection moulding process with a subsequent cooling process, are reduced. The frame 1, 1a has an assembly shoulder 7 for attaching the ventilation arrangement in a venting channel, in particular of a motor vehicle. A seal 9 may be provided in the assembly shoulder 7 for air-tight sealing of a vehicle interior 8 with respect to the venting channel. To attach the ventilation flap arrangement in the venting channel to vent a vehicle interior 8, the ventilation flap arrangement is inserted along an assembly direction 10, 10a into the venting channel. An assembly of the ventilation flap arrangement from an opening of the venting channel opposing the vehicle interior 8 in the direction of the motor vehicle interior 8 takes place in the assembly direction 10 and an assembly of the ventilation flap arrangement from the motor vehicle interior 8 into the venting channel takes place in the assembly direction 10a. The assembly shoulder 7 is used for a defined positioning of the ventilation flap arrangement in the venting channel. The cover flaps 4 produced from flexible material are, in each case, held by a receiving groove 3, which is formed by two side cheeks 5 provided on a support rib 2, the cover flaps 4 in the rest state, i.e. there is no venting, resting in a sealing manner on a support rib 2 adjacent to the support rib 2 being used to hold the cover flap 4. This ensures that the ventilation flap arrangement allows an escape of air from the vehicle interior 8 into the venting channel in the manner of a check valve and simultaneously prevents air flowing from the venting channel into the vehicle interior 8.

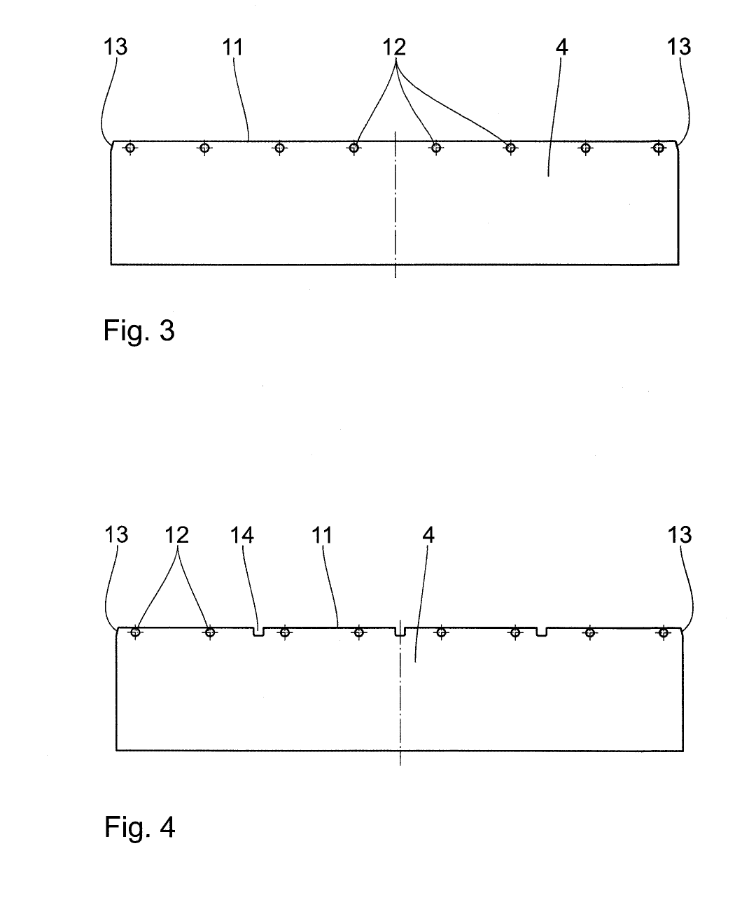

A flexible cover flap 4 shown in FIG. 3 has an extended rectangular shape and has a plurality of openings 12 arranged close to its one longitudinal edge 11, as well as a respective side insertion bevel 13 on one end of the longitudinal edge 11 for easier insertion of the cover flap 4 into a receiving groove, not shown. The openings 12 are round, but they may also be rectangular, square or configured as slots. The significance of the openings 12 will be described below. The flexible cover flap 4 may also be designed without openings 12 and without insertion bevels 13.

FIG. 4 shows a flexible cover flap 4 which is similar to the one shown in FIG. 3 and comprises additional notches 14 which have a rectangular, in particular square shape and are used to receive reinforcement ribs 15 (cf. FIG. 6) of a receiving groove, not shown, during an assembly process of the cover flaps 4 on the frame 1, 1a. An outer contour of the reinforcement rib 15 corresponds with the shape of the notch 14.

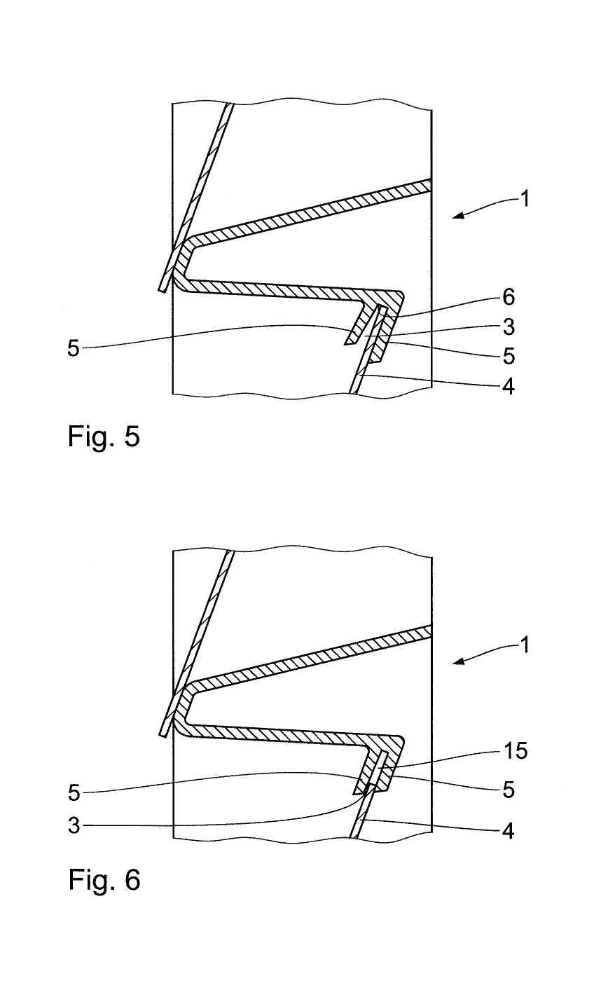

FIG. 5 shows the attachment of a cover flap 4 according to FIG. 3 on a frame 1 in a first production step. For this purpose, the cover flap 4 is inserted in a receiving groove 3 which is formed by two side cheeks 5 and tapers toward a groove base 6, so the insertion of the cover flap 4 into the receiving groove 3 is additionally facilitated.

FIG. 6 shows the attachment of a cover flap 4 according to FIG. 4 on a frame 1 in a first production step. The cover flap 4 is also inserted here into a receiving groove 4 formed by two side cheeks 5, the side cheeks 5 of the receiving groove 3 being arranged substantially parallel to one another. The cover flaps 4 are positioned in the receiving groove 3 by the receiving of reinforcement ribs 15 of the receiving groove 3 in notches of the cover flap 4.

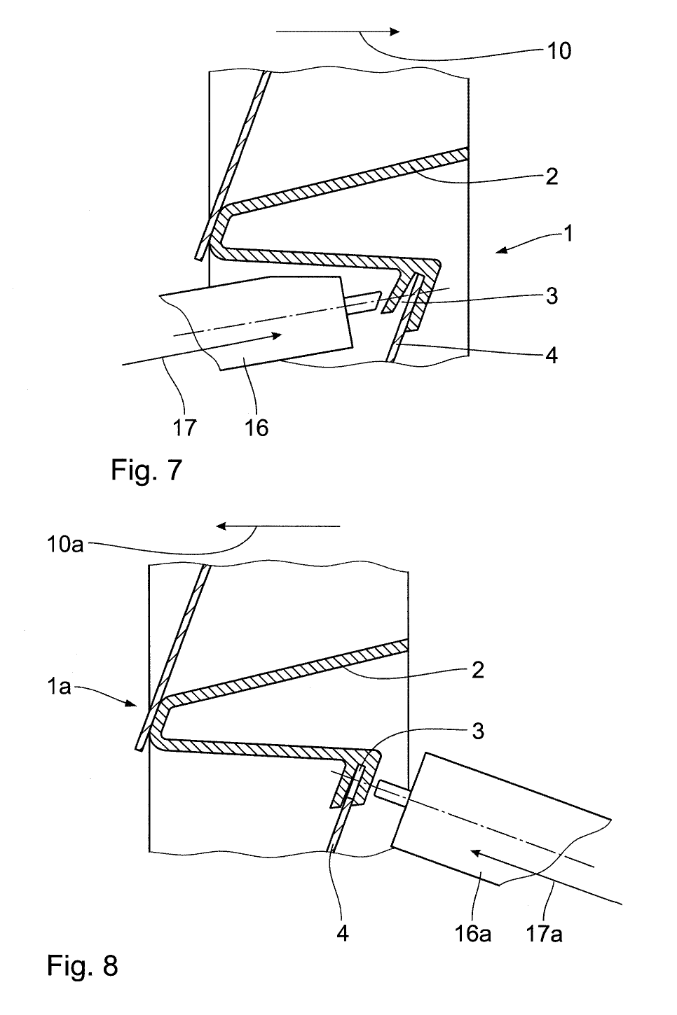

FIGS. 7 and 8 show embodiments of a one-sided embossing process as a production step following the first production step shown in FIG. 5 or 6 for the non-detachable connection of a cover flap 4 to a receiving groove 3 on a support rib 2 by an embossing die 16, 16a. Depending on an assembly direction 10, 10a, an embossing direction 17, 17a, along which the embossing die 16, 16a acts against a side cheek 5 of the receiving groove 3, varies. The embossing direction 17, 17a substantially corresponds to the assembly direction 10, 10a. The geometry of the embossing die 16, 16a is adapted to the respective shape of the support ribs 2 of a frame 1, 1a of the receiving groove 3 and the cover flap 4 and a material to be embossed. The embossing direction 17, 17a may also be selected in accordance with a desired visibility of an embossing.

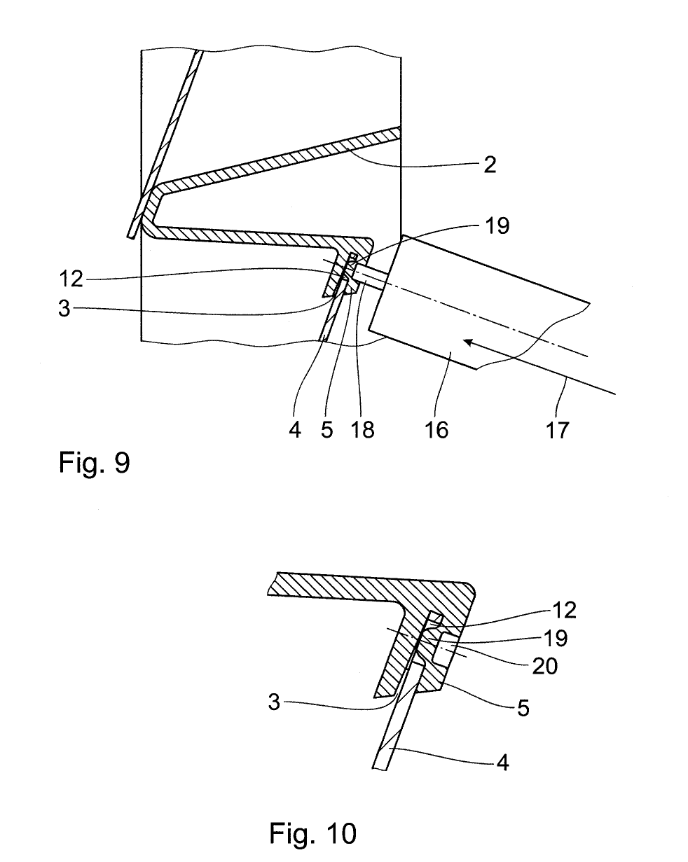

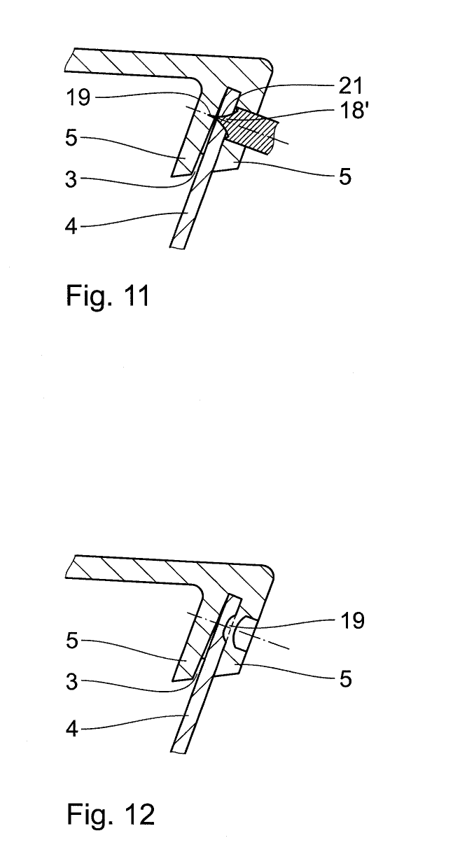

A non-detachable connection of a cover flap 4 to a receiving groove 3, shown in FIGS. 9 and 10, is produced by one-sided embossing with an embossing die head 18 of an embossing die 16 along an embossing direction 17. As a result of the embossing process, a side cheek 5 of the receiving groove 3 is formed with the embossing die 16 in such a way that an embossed projection 19 of the side cheek 5 is formed. Once the embossing process has been completed, an embossed projection 19 projects into each opening 12 of the cover flap 4. The formed side cheek 5, after the embossing process, has a restricted area 20, which corresponds with an embossed projection 19 and has been produced by the action of the embossing die head 18. The embossed projection 19 and the restricted area 20 have a round cross-sectional face corresponding to the embossing die head 18. The cross-sectional face of the embossed projection 19 and the restricted area 20 may, however, also be rectangular or square, the shape of the embossed projection 19 corresponding with the shape of the opening 12.

FIG. 11 shows a non-detachable connection, shown enlarged, of a cover flap 4 with receiving groove 3, a one-sided embossing process being carried out with a substantially conical head 18′ of an embossing die. The cover flap used has no openings, so, as a result of the embossing process, a side cheek 5 of the receiving groove 3 is formed with the embossing die in such a way that an embossed projection 19 of the side cheek 5 is formed. The cover flap is thus pierced by a tapering end of the conical embossing head with the formation of a perforation 21, the embossed projection 19 in the perforation 21 being formed by the subsequent pressing of material. The embossed projection 19 of one side cheek 5 may be connected to the other side cheek 5 of the receiving groove 3.

FIG. 12 also shows a non-detachable connection, shown enlarged, of a cover flap 4, which has no openings, to a receiving groove 3. As a result of an embossing process, a side cheek 5 of the receiving groove 3 is formed with an embossing die in such a way that an embossed projection 19 of the side cheek 5 projects into the receiving groove 3 receiving the cover flap 4. As a result, the cover flap 4 is clamped in the receiving groove 3.

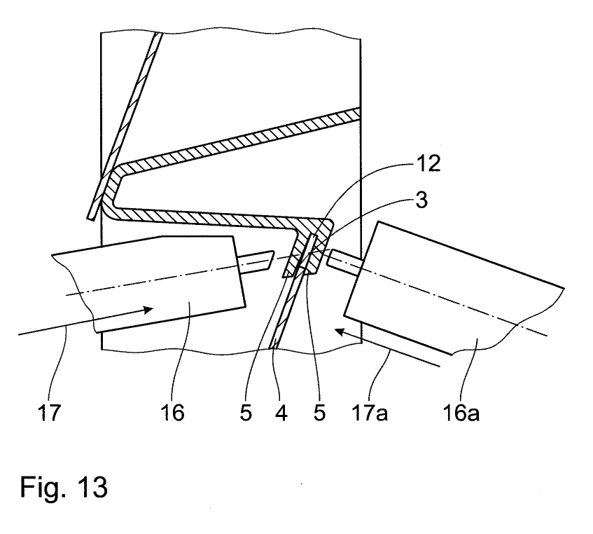

A two-sided embossing process analogous to the one-sided embossing process shown in FIGS. 7 and 8 is made possible with an embossing die pair 16, 16a shown in FIG. 13. In this case, the embossing die pair 16, 16a acts on the two side cheeks 5 of a receiving groove 3 of a ventilation flap arrangement with the formation of a respective embossed projection of the two side cheeks 5. The side cheek 5 is formed less to produce the embossed projection in the two-sided embossing process than to form an embossed projection in a one-sided embossing process. Each embossing die 16, 16a acts in the two-sided embossing process along an embossing direction 17, 17a, the embossing directions 17, 17a having various orientations, which intersect in a plane spanned by a cover flap 4 at a respective opening 12.

The frame 1 that has a plurality of support ribs 2 each with two side cheeks 5 attached in one piece thereon is made of plastics material, in particular by the injection moulding method. The cover flap 4 consists of a soft elastic material and is in particular produced by punching. An embossing process for a non-detachable connection of the cover flap 4 to a receiving groove 3, which is formed by two side cheeks 5, may take place by cold embossing at room temperature with a suitable selection of material. A possible material is a plastics material available under the name “Baroplastic” based on a mixture of a comparatively rigid polystyrene and relatively soft polybutyl acrylate. This material can already be shaped merely by pressure at room temperature.

A region of the side cheek 5 to be embossed can also be heated to a temperature in the range between a dimensional stability temperature and a melting temperature of a material to be embossed in order to achieve better formability of the side cheek 5. A preferably used material is PP 6.2 recyclate, the dimensional stability temperature of which is 86° C. and the melting temperature of which is 163° C. To reach these temperatures, an embossing die 14, 14a heated to 280° C. to 350° C. may be used. Alternatively, the region to be embossed of the side cheek 5 may also be heated by radiation heat emitted by a heating element heated to 400° C. to 550° C. The formability of the side cheek 5 can also be increased in that the region to be embossed is acted upon by ultrasound. A frequency range preferred for this, as a function of a sonotrode used, is 20 kHz to 40 kHz.

Improved stability of the embossing connection can be achieved in that an adhesive connection is provided between an embossed projection of a first side cheek as a result of the action of temperature and/or ultrasound and a second side cheek arranged opposing the first side cheek. The plastics materials acrylonitrile butadiene styrene (ABS), polyamide 6 (PA 6), polypropylene (PP), polyphenylene sulphide (PPS), polycarbonate (PC) and polystyrene (PS) have proven particularly suitable for an embossing process at increased temperature and/or upon the action of ultrasound. The plastics materials acrylonitrile butadiene styrene with polycarbonate blend (ABS-PCB), polyoxymethylene (POM), polyamide 6.6 (PA 6.6) and polybutylene terephthalate (PBT) are well suited to temperature-assisted embossing but only to a limited extent for embossing with ultrasound.

What is claimed is:

1. A ventilation flap arrangement, in particular for venting a motor vehicle interior, comprising
at least one flexible cover flap (4) and
a frame (1; 1a) for holding the at least one cover flap (4), the frame (1; 1a) for a cover flap (4) having a receiving groove (3) formed by two side cheeks (5) and the cover flap (4) being non-detachably connected to the receiving groove (3) of the frame (1; 1a) by embossing.

2. A ventilation flap arrangement according to claim 1, wherein at least one side cheek (5) projects with an embossed projection (19) into at least one opening (12) formed close to the edge on the cover flap (4).

3. A ventilation flap arrangement according to claim 1, wherein the cover flap (4) is connected in a clamping manner to the receiving groove (3) by at least one embossed projection (19) of one side cheek (5).

4. A ventilation flap arrangement according to claim 1, wherein the at least one cover flap (4) consists of a soft elastic material.

5. A ventilation flap arrangement according to claim 1, wherein the at least one cover flap (4) has at least one notch (14) and the receiving grooves (3) have at least one reinforcement rib (15) corresponding to the at least one notch (14).

6. A ventilation flap arrangement according to claim 1, wherein the frame (1; 1a) has a support rib (2), on which the side cheeks (5) of a receiving groove (3) are attached.

7. A ventilation flap arrangement according to claim 1, wherein the cover flaps (4) rest in a sealing manner on the support ribs (2) in the rest state.

8. A ventilation flap arrangement according to claim 1, wherein the receiving grooves (3) taper to a groove base (6).

9. A ventilation flap arrangement according to claim 1, wherein the frame (1; 1a) has an assembly shoulder (6) for attachment in a venting channel, in particular of a motor vehicle.

10. A method for producing a ventilation flap arrangement, in particular for venting a motor vehicle interior, comprising the following method steps:
providing at least one flexible cover flap (4),
providing a frame (1; 1a) to hold the at least one cover flap (4), the frame (1; 1a) for a cover flap (4) having a receiving groove (3) formed by two side cheeks (5),
inserting the cover flap (4) between the two side cheeks (5) of the receiving groove (3) of the frame (1; 1a) and
non-detachably connecting the cover flap (4) to the receiving groove (3) by embossing.

11. A method according to claim 10, wherein at least one side cheek (5) is deformed by an embossing die (16; 16a) in such a way that an embossed projection (19) of the at least one side cheek (5) projects into at least one opening (12) formed close to the edge on the cover flap (4).

12. A method according to claim 11, wherein the embossed projection (19) of the side cheeks (5) is produced by an embossing die pair (16; 16a) acting thereon on both sides.

13. A method according to claim 10, wherein at least one side cheek (5) is deformed by the embossing die (16; 16a) in such a way that the cover flap (4) is clamped in the receiving groove (3) by an embossed projection (19).

14. A method according to claim 10, wherein the region to be embossed of the at least one side cheek (5) is heated to a temperature in the range between a dimensional stability temperature and a melting temperature of a material to be embossed.

15. A method according to claim 10, wherein the region to be embossed of the at least one side cheek (5) is acted upon by ultrasound.
